(19) United States
(12) Patent Application Publication
(10) Pub. No.: US 2003/0087746 A1
(43) Pub. Date: May 8, 2003

(54) Alkali-containing aluminum borosilicate glass and utilization thereof

(76) Inventors: Simone Ritter, Mainz (DE); Ulrich Peuchert, Mainz (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/182,840

(22) PCT Filed: Jan. 31, 2001
(86) PCT No.: PCT/EP01/01001

(30) Foreign Application Priority Data
Feb. 4, 2000 (DE) 10005088.3

(51) Int. Cl. C03C 3/091; C03C 3/093; C03C 3/11; C03C 3/118

(52) U.S. Cl. 501/66; 501/67; 501/56; 501/59

(57) ABSTRACT

The invention concerns alkali-poor or alkali-free alkaline earth aluminum borosilicate glasses having the following composition (weight percent based on oxides) SiO₂>55-70; B₂O₃ 1-8; Al₂O₃ 10-18; Na₂O>1-5; K₂O 0-4; with Na₂O+K₂O >1-5; MgO 0-5; CaO 3-<8; SrO 0.1-8; BaO 4.5-12; with MgO+CaO+SrO+BaO 10-25; SnO₂ 0-15; ZrO₂ 0-3; TiO₂ 0-2; ZnO 0-2. Said glasses can be used especially as substrates in thin layer photovoltaics, especially for CIS-based solar cells.

Die Erfindung betrifft alkaliarme bzw, alkalifreie Erdalkalialuminoborosilicatgläiser mit einer Zusammen-setzung (in Gew,-% auf Oxidbasis) SiO₂>55-70; B₂O₃ 1-8; Al₂O₃ 10-18; Na₂O>1-5; K₂O 0-4; mit Na₂O+K₂O>1-5; MgO 0-5; CaO 3-<8; SrO 0,1-8; BaO 4,5-12; mit MgO+CaO+SrO+BaO 10-25; SnO₂ 0-15; ZrO₂ 0-3; TiO₂ 0-2; ZnO 0-2. Die Gläser sind besonders geeignet für die Verwendung als Substrate in der Dünnschichtphotovoltaik, insbesondere für Solarzellen auf CIS-Basis.

The subject matter of the invention is alkali-containing aluminum borosilicate glasses. The subject matter of the invention is also the use of these glasses.

When electrical energy is obtained by means of photovoltaics, the property of certain semiconductor materials of absorbing light from the visible spectrum and the near UV and IR with formation of free charge carriers (e⁻/hole pairs) is used. When there is an internal electrical field in the solar cell, implemented by a p-n junction in the photoactive semiconductor material, they can be spatially separated according to the diode principle and lead to a potential difference, and with suitable contact-making, to current flow. Commercially available solar cell systems contain almost exclusively crystalline silicon as the photoactive material. It is formed as so-called “solar grade Si” among others as scrap in the production of high-purity monocrystals for complex integrated components (chips).

The possible applications of photovoltaic systems can be roughly divided into two groups. They are on the one hand “non-grid coupled” applications which are used in remote areas for lack of energy sources which can be installed with comparable ease. In contrast, “grid-linked solutions” in which solar power is supplied to an existing fixed network, are still not economical due to the high cost of solar current.

Future market development of photovoltaics, especially for grid-linked solutions, is thus largely dependent on the cost reduction potential in the production of solar cells. A great potential is seen in the implementation of thin layer concepts. Here photoactive semiconductor materials, especially highly absorbing compound semiconductors, are deposited on high temperature-resistant substrates, for example glass, which are as economical as possible, in layers a few μm thick. The cost reduction opportunities lie mainly in low semiconductor material consumption and high automation capacity in production, in contrast to largely manual wafer-Si solar cell production.

A very promising thin layer concept is solar cells based on a I-III-VI₂ compound semiconductor Cu(In,Ga) (S,Se)₂ (“CIS”). This material satisfies important requirements such as for example high absorption of the incident light and very good chemical stability of the compound. The similar applies to solar cells based on the II-VI compound semiconductor CdTe.

The good miscibility of the ternary CIS end members CuInS₂, CuInSe₂, CuGaS₂, and CuGaSe₂, makes it possible to adjust the stoichiometry which is optimally matched to the absorption of important energy regions of the solar spectrum by element substitution. In particular, by implementing tandem solar cells with CIS layers of different stoichiometries, efficiencies of up to 18% can be achieved on a laboratory scale. Thus, there are good prospects for achieving efficiencies of more than 12% on a production scale.

In CIS layers the very complex production of the CIS layer composite which is very demanding in terms of production engineering is disadvantageous, mainly in comparison to competing thin layer concepts such as solar cells based on CdTe or amorphous silicon. Thus, in several working steps, by vapor-deposition (sputtering), vacuum coating and chemical deposition on a suitable substrate a layer package with a total thickness of about 2 microns, consisting of a molybdenum back contact, CIS layer, buffer or matching layer of CdS and a ZnO window layer is applied to a suitable substrate. To automate the formerly complex wiring of individual modules, structuring is impressed by mechanical scribing or laser treatment between the individual processes in the layer composite. The scribing is however critical with respect to possible decomposition of the semiconductor material or the evaporation of components from the stoichiometrically defined photoactive CIS layer. In addition, in the production of a CIS layer composite problems arise with respect to adhesion mainly of the molybdenum back contact on the glass substrate which can be expressed for example in flaking of the Mo in the production process. One reason for this is the lack of thermal matching of the cheap soda-lime glass which is used for cost reasons, with thermal expansion of roughly 9×10⁻⁶/K, to the Mo layer with thermal expansion of roughly 5×10⁻⁶/K.

Development of a special glass suitable for CIS technology must take into account the requirement for thermal matching to Mo. The value of the thermal expansion α_{20/300} should accordingly be in the range from roughly 4.5 to 6.0×10⁻⁶/K, ideally it is a maximum 5.5×10⁻⁶/K. With respect to ensuring fast deposition rates of CIS in good quality, which can be done by coating temperatures as high as possible, high temperature stability is furthermore desirable, i.e. the transformation temperature T_{g} of the glass should assume values as high as possible. Feasibly the glass has a transformation temperature above 630° C., ideally above 650° C. As a result of the low transformation temperature of roughly 520° C. of the soda-lime glass used, only coating temperatures of a maximum 500° C. have been possible to date.

Furthermore, the glass for use as a substrate for CIS should have a proportion of alkali oxides, especially Na₂O, as high as possible. In this way the number of charge carriers can be increased by the Na ions diffusing into the photoactive layer, by which the efficiency of the solar cell rises.

In addition to the substrate technologies which are common in thin layer photovoltaics (the semiconductor rests on bases of materials like glass, metal, plastic, ceramic) with the indicated layers and the cover glass with light action through the cover glass, a superstrate arrangement has been established especially in CdTe photovoltaics. Here, before striking the semiconductor layer, the light first passes through the carrier material. In this way the cover glass becomes superfluous. To achieve high efficiencies, for these substrates high transparency in the VIS/UV range of the electromagnetic spectrum is necessary. Thus, for example, semitransparent glass ceramics are unsuitable here as the carrier materials.

The glasses should furthermore have sufficient mechanical stability and resistance to water and also the reagents which may be used in the production process. This applies especially to the superstrate concept in which no cover glass protects the solar module against ambient effects. Furthermore, it should be possible to economically produce glasses in adequate quality with respect to the absence of bubbles or few bubbles and crystalline inclusions.

For use as bulb glasses for halogen lamps, glasses which can be exposed to high thermal loads are known which are matched to the thermal expansion of molybdenum. These glasses are however necessarily alkali-free since otherwise the regenerative halogen cycle of the lamp would be disrupted.

By simply adding one or more alkali oxides however the desired physical and chemical properties are adversely affected, especially the transformation temperature is reduced and the thermal expansion increased, so that instead, new development of the glass composition is necessary to meet the desired requirement profile.

This is done best by alkali-containing-aluminum borosilicate glasses with a high proportion of alkaline-earth oxides as network modifiers. The known glasses described in the following steps however have disadvantages with respect to their chemical and physical properties and/or their preparation possibilities and do not satisfy the entire catalog of requirements.

JP 4-83733 A describes glasses of the system SiO₂—Al₂O₃—Na₂O—MgO. The high Al₂O₃-containing glasses as is apparent from the example have very low coefficients of expansion.

In JP 1-201043 A glasses of high strength are described which are suited as carriers for optomagnetic plates and which have very high coefficients of expansions.

The same applies to the glasses of JP 11-11975, U.S. Pat. No. 5,854,152 and JP 10-722735 A which contain at least 6% by weight alkali oxides.

JP 9-255356 A, JP 9-255355 A and JP 9-255354 A disclose SiO₂-poor AL₂O₃-poor glasses with likewise very high thermal expansions which are used as glass substrates for plasma display panels.

Like these glasses which are relatively low in boric acid, preferably free of boric acid, the boric acid-free, temperature-resistant glasses for solar applications from JP 61-236631 A and JP 61-261232 A are difficult to melt and tend to devitrification.

U.S. Pat. No. 3,984,252 and DE-AS 27 56 555 of the applicant describe thermally prestressable glasses which with coefficients of thermal expansion of α_{20/300} of up to 6.3×10⁻⁶/K and 5.3×10⁻⁶/K encompass both the thermal expansion of Mo and also of CdTe. In particular, as a result of the absence of SrO, in production in the drawing process the glasses will be susceptible to crystallization. The latter also applies to the SrO-free substrate glasses of JP 3-146435 A and glasses from U.S. Pat. No. 1,143,732, the latter being highly alkali-containing, as shown by the examples; this means high thermal expansion and relatively low temperature stability.

DE-AS 19 26 824 describes layered bodies consisting of a core part and an outside layer with different coefficients of thermal expansion. The outside layers with coefficients of thermal expansion between 3.0×10⁻⁶/K and 8.0×10⁻⁶/K can vary in their composition within wide limits of many possible components, the high CaO-containing SrO-free glasses as follows from the examples tending toward devitrification.

Transparent glass ceramics, among others, suitable for flat displays and solar cells, are described by JP 3-164445 A. The cited examples have high T_{g} values>780° C. and in their thermal expansion are well matched to CdTe. As a result of their very high zinc contents they are however not suited for the float production process. The same applies to transparent, mullite-containing glass ceramics chromium doped with a maximum of 1% by weight from EP 168 189 A2 and transparent glass garnet glass ceramics from JP 1-208343 A with possible applications in solar collectors. The high transparency necessary for use as a superstrategin CdTe solar cell systems is however not ensured either by glass ceramics which, depending on the grain size of crystallites, have a transmission which is reduced compared to glasses, nor by milky-white opal glasses as are described in FR 2126960.

For use as substrates for coatings, glass ceramics have the advantage of high temperature resistance, but a major disadvantage is their production costs which are high as a result of the necessary ceramicization; this is not acceptable in the production of solar cells based on the effects of the price of solar current.

The object of the invention is to make available glasses which meet the indicated physical and chemical requirements on glass substrates for thin layer photovoltaic technologies based on compound semiconductors, especially based on Cu(In,Ga)(Se,S)₂ or CdTe, glasses which have a temperature resistance sufficient for deposition of the layers at high temperatures, i.e. a transformation temperature Tg of at least 630° C., which have a process-favorable processing temperature range, and have high quality with respect to few bubbles and chemical resistance which corresponds to at least soda-lime glasses.

This object is achieved by the aluminum borosilicate glasses as claimed in claim 1.

The glasses contain balanced proportions of the network formers SiO₂ and Al₂O₃ with relatively low proportions of the network former B₂O₃. Thus, at low melting and processing temperatures very high temperature resistance of the glass is achieved.

In particular:

The glasses contain>55-70% by weight SiO₂. At low contents the chemical, especially the acid resistance of glasses, deteriorates, at higher proportions the thermal expansion assumes overly low-values. In the latter case moreover an increasing devitrification tendency can be observed.

The glasses contain 10-18% by weight, preferably>12-17% by weight Al₂O₃. A higher proportion adversely affects the process temperatures in hot shaping, overly low contents can entail greater crystallization susceptibility of the glasses. Limitation of the maximum content to<14% by weight is quite especially preferred.

The glasses contain at least 1% by weight, preferably at least 3% weight B₂O₃. The indicated low minimum proportion makes itself beneficial in the melt flow and in the crystallization behavior. The desirable high transformation temperature is ensured by limitation of the maximum B₂O₃ content to 8% by weight. The relatively low boric acid proportion moreover acts beneficially on the chemical resistance of the glass, especially relative to acids. The maximum content of B₂O₃ is preferably limited to 7% by weight, especially preferably to 5% by weight; quite especially preferably to<5% by weight.

The desired coefficient of thermal expansion α_{20/300} between 4.5×10⁻⁶/K and 6.0×10⁻⁶/K can be achieved with an alkaline earth content between 10 and 25% by weight, preferably between 11 and 23% by weight and an alkali oxide content between>1 and 5% by weight, preferably<5% by weight, by a host of combinations of individual oxides. An alkali oxide content of less than 4% by weight is especially preferred, especially to obtain glasses with coefficients of expansion<5.5×10⁻⁶/K.

Glasses with low coefficients of expansion (α_{20/300}≦5.5×10⁻⁶/K) contain rather little alkaline earth oxides, preferably 11-20% by weight, while glasses with higher coefficients of expansion α_{20/300} have relatively high alkaline earth proportions.

In particular:

The glasses contain relatively high proportions on BaO, specifically 4.5 to 12% by weight, preferably>5 to 11% by weight, combined with low to medium contents of SrO, specifically 0.1 to 8% by weight, preferably at most 4% by weight. The indicated proportions are especially favorable for the desired high temperature resistance and low crystallization tendency. Rather small proportions of the indicated oxides are advantageous with respect to the low density of glass and thus low weight of the product. The limitation of the SrO content to the indicated preferred maximum value is positive for good processability of the glass.

The glasses can contain up to 5% by weight, preferably up to 4% by weight MgO. Rather high proportions prove favorable with respect to the property of low density. Rather low portions are favorable with respect to chemical resistance as high as possible and minimization of the tendency to devitrification. Since low proportions cause a reduction of the processing temperature, the presence of at least 0.5% by weight MgO is preferred.

The component CaO acts on the glass properties similarly to MgO, its being more effective than MgO with respect to increasing thermal expansion. The glasses contain 3 to<8% by weight CaO.

The glasses contain>1 to 5% by weight alkali oxides as 1>to 5% by weight, preferably up to<5% by weight, Na₂O and 0-4% by weight, preferably 0-2.5% by weight, especially preferably 0-1% by weight K₂O, its being preferable that at least the overwhelming proportion of Na₂O is formed. The alkali oxides improve the meltability and reduce the devitrification tendency. The limitation of the indicated maximum content is necessary to ensure high temperature stability. Higher contents, especially of Na₂O, reduce the transformation temperature and increase the thermal expansion. For use as a CdTe substrate, glasses with<3% by weight alkali oxides are preferred. For use as a CIS substrate, glasses with≧3% by weight alkali oxides are preferred, since efficiency can be increased by Na⁺diffusion into the photoactive layer.

The glasses can contain up to 2% by weight, preferably up to 1% by weight ZnO. With its effect on the viscosity characteristic which is similar to boric acid, ZnO acts on the one hand to loosen the network, on the other hand increases the thermal expansion, but not to the extent as the alkaline earth oxides. Especially when processing the glasses in a float process the content of ZnO is preferably limited to rather small amounts (≦1% by weight) or ZnO is entirely omitted. Higher proportions increase the danger of disruptive ZnO coatings on the glass surface. They can be formed by vaporization and subsequent condensation in the hot shaping range.

The glasses can contain up to 3% by weight ZrO₂. ZrO2 increases the temperature resistance of the glass. At contents of more than 3% by weight, however due to slight solubility of ZrO₂, melt relics in the glasses can occur. Preferably the presence of ZrO₂ with at least 0.1% by weight is preferred.

The glasses can contain up to 2% by weight, preferably up to 1% by weight TiO₂. TiO₂ reduces the tendency of the glasses to solarization. At contents of more than 2% by weight color casts can occur due to complex formation with Fe³⁺ ions.

The glasses can contain up to 1.5% by weight SnO₂. SnO2 is a highly effective refining agent especially in high-melting alkaline earth aluminum borosilicate glass systems. Tin oxide is used as SnO₂, and its quadrivalent state is stabilized by adding other oxides such as for example TiO₂ or by adding nitrates. The content of SnO₂ due to its slight solubility at temperatures below the processing temperature V_{A} is limited to the indicated upper limit. Thus, precipitations of microcrystalline Sn-containing phases are prevented.

The glasses can be processed into flat glasses with different drawing processes, for example microheat down drawn, up draw or overflow fusion processes.

The glass can contain as an additional or the sole refining agent up to 1.5% by weight As₂O₃ and/or Sb₂O₃ and/or CeO₂. The rather low melting glasses can also be refined with alkali halogenides. Thus, for example, salt contributes to refinement by its vaporization starting at roughly 1410° C., some of the NaCl used being found again as Na₂O. When 1.5% by weight NaCl is added, roughly 0.1% by weight Cl⁻ remain in the glass. Therefore the addition of 1.5% by weight Cl⁻ (for example as BaCl₂ or NaCl), F⁻ (for example as CaF₂ or NaF) or SO₄²⁻ (for example BaSO₄) each is possible. The sum of As₂O₃, Sb₂O₃, CeO₂, Cl⁻, F⁻, and SO₄²⁻ however should not exceed 1.5% by weight. When the refining agents As₂O₃ and Sb₂O₃ are omitted, the glass can also be processed with the float process.

Embodiments:

Glasses from conventional raw materials were melted in quartzal crucibles at 1620° C. The melt was refined for 90 minutes at this temperature, then poured into an inductively heated platinum crucible and stirred for 30 minutes at 1560° C. for homogenization.

The table shows eleven examples of glasses as claimed in the invention with their compositions (in % by weight based on oxide) and their most important properties. The following are given:

density ρ [g/cm³]

coefficient of thermal expansion α_{20/300} [10⁻⁶/K]

dilatometric transformation temperature T_{g} [° C.] as per DIN 52324

temperature at a viscosity 10¹³ dPas (designated T 13 [° C.]

temperature at a viscosity 10^{7.6} dPas (designated T 7.6 [° C.]

temperature at a viscosity 10⁴ dPas (designated T 4 [° C.]

hydrolytic resistance as per DIN ISO 719 “H” (μg Na₂O/g).

At a base equivalent as Na₂O per g glass grains of≦31 μg/g the glasses belong to hydrolytic class 1 (“chemically highly resistance glass”).

acid resistance as per DIN 12166 “S” [mg/dm²]. At a weight loss of more than 0.7 to 1.5 mg/dm² the glasses belong to acid class 2 and at more than 1.5 to 15 mg/dm² to acid class 3.

alkali resistance as per ISO 695 “L” [mg/dm²]. At a weight loss of 75 mg/dm² the glasses belong to alkali class 1 and at more than 75 to 175 mg/dm² to alkali class 2.

upper devitrification limit OEG [° C.], i.e. liquidus temperature at 1 hour annealing

maximum crystal growth rate Vₘₐₓ [μm/h] for 1 hour annealing averaged transmission at wavelengths between 400 and 700 nm (sample thickness 1.8 mm) τ_{φ} (400-700 nm).

refractive index n_{d}

Glasses nos. 1-8 and 11 were refined with the addition of 1.5% by weight NaCl. NaCl vaporized almost completely. Cl⁻ is therefore not listed in the table.

TABLE
Compositions (in % by weight on an oxide basis) and
important properties of glasses as claimed in the invention

| | 1 | 2 | 3 | 4 | 5 | 6 | 7 | 8 | 9 | 10 | 11 |
|---|---|---|---|---|---|---|---|---|---|---|---|
| SiO₂ | 64,70 | 61,60 | 59,35 | 59,55 | 56,30 | 65,00 | 66,10 | 68,30 | 63 00 | 60,00 | 58,00 |
| B₂O₃ | 5,60 | 7,00 | 6,70 | 4,90 | 4,90 | 3,00 | 3.10 | 1,00 | 4,30 | 5,65 | 3.00 |
| Al₂O₃ | 12,10 | 12,35 | 12,60 | 14.75 | 15,30 | 13.55 | 12,30 | 10,30 | 15,50 | 14,50 | 16,90 |
| MgO | 2,50 | 4,00 | 3,90 | 1,90 | 2.15 | 0,50 | 1,00 | — | 1,00 | 2,50 | 2,00 |
| CaO | 4,20 | 3,40 | 4,00 | 4,90 | 5,55 | 7,90 | 7 50 | 3,00 | 6.50 | 4,30 | 5,00 |
| SrO | 1,40 | 0,50 | 0,90 | 2,15 | 2,75 | 2,95 | 2,30 | 8,00 | 0,10 | 0,10 | 0,50 |
| BaO | 5,90 | 7,40 | 7,95 | 7,20 | 7,75 | 5,10 | 5,00 | 4,50 | 6,40 | 9,75 | 8,60 |
| ZrO₂ | — | 1,10 | 1,55 | 2,60 | 3,00 | — | 0,10 | — | — | — | 1,50 |
| Na₂O | 3,40 | 1,65 | 2,15 | 2,05 | 1,60 | 1,10 | 2,60 | 4,90 | 2,50 | 3.00 | 4,50 |
| K₂O | 0,20 | 1.00 | 0,90 | — | 0,70 | 0,90 | — | — | 0,50 | — | — |
| SnO₂ | — | — | — | — | — | — | — | — | 0,20 | 0,20 | — |
| p [g/cm³] | 2,510 | 2,531 | 2,579 | 2,604 | 2,659 | 2,554 | 2,543 | 2,573 | 2,532 | 2,587 | 2,647 |
| α_{20/300} [10⁻⁶/K] | 5,06 | 4,69 | 5,09 | 4,72 | 4,97 | 4,81 | 5,10 | 5.89 | 4,68 | 4,89 | 5,89 |
| T_{g} [° C.] | 635 | 649 | 643 | 677 | 679 | 688 | 663 | 644 | 675 | 650 | 654 |
| T 13 [° C.] | 650 | 664 | 660 | 694 | 692 | 704 | 680 | 654 | n.b. | n.b. | 670 |
| T7,6 [° C.] | 885 | 894 | 880 | 926 | 911 | 944 | 911 | n.b. | n.b. | n.b. | n.b. |
| T4 [° C.] | 1269 | 1253 | 1224 | 1278 | 1239 | 1317 | 1285 | 1299 | 1316 | 1255 | 1246 |
| H [μg Na₂O/g] | n.b. | 14 | n.b. | 14 | 13 | n.b. | 12 | n.b. | 7 | 7 | n.b. |
| S [mg/dm²] | n.b. | 13,8 | n.b. | 8,1 | n.b. | n.b. | 1,2 | n.b. | n.b. | n.b. | n.b. |
| L [mg/dm²] | n.b. | 97 | n.b. | 71 | 70 | n.b. | 70 | n.b. | n.b. | n.b. | n.b. |
| OEG [° C.] | n.b. | 1165 | n.b. | n.b. | n.b. | n.b. | frei | n.b. | 1200 | 1150 | n.b. |
| vₘₐₓ [μm/h] | n.b. | 48 | n.b. | n.b. | n.b. | n.b. | frei | n.b. | 6 | 5 | n.b. |
| τ_{φ}(400-700) | n.b. | 92,5 | n.b. | 91,3 | 91,3 | n.b. | 91,6 | n.b. | n.b. | n.b. | n.b. |
| n_{d} | n.b. | 1,520 | n.b. | 1,531 | 1,540 | n.b. | 1,522 | n.b. | n.b. | n.b. | n.b. |

n.b. = not determined

As the embodiments illustrate, the glasses as claimed in the invention have the following advantageous properties;

thermal expansion α_{20/300} between 4.5×10⁻⁶/K and 6.0×10⁻⁶/K, in preferred embodiments, i.e. especially at alkali oxide contents<4% by weight between 4.5×10⁻⁶/K and 5.5×10⁻⁶/K, thus matched to the expansion behavior of the Mo layer applied as an electrode in CIS technology (α roughly 5×10⁻⁶/K) or to the semiconductor material CdTe (α a roughly 5×10⁻⁶/K).

with Tg>630° C., in preferred embodiments, i.e. especially at Al₂O₃ contents>12% by weight and/or B₂O₃ contents<5% by weight,≧650° C., a transformation temperature and thus temperature resistance which are especially rather high for the coating process in the production of CIS and also CdTe solar cells

a temperature at a viscosity of 10⁴ dPas of a maximum 1320° C.; this means a process-favorable processing range, and good devitrification stability. These two properties make it possible to produce the glass as flat glass with different drawing processes, for example, micro sheet down draw, up draw, or overflow fusion processes, and in a preferred version, when it is free of As₂O₃ and Sb₂O₃, also with the float process.

very high hydrolytic resistance; this makes them relatively inert against the chemicals used in the production of solar cells and to environmental effects. This is illustrated by the embodiments' belonging to hydrolytic class 1, while Ca-Na glass has hydrolytic resistance of hydrolytic class 3.

Furthermore, the glasses have high solarization stability and high transparency. This is especially important for the superstrate arrangement in CdTe solar cells.

With further consideration of high quality with respect to the absence of bubbles or low bubble content the glasses are outstandingly suited for use as substrate glass in the thin layer photovoltaics, especially based on compound semiconductors, especially based on Cu(In,Ga)(Se,S)2 and CdTe.

1) Aluminum borosilicate glass which has the following composition (in % by weight on an oxide basis):

| | |
|---|---|
| SiO₂ | >55-70 |
| B₂O₃ | 1-8 |
| Al₂O₃ | 10-18 |
| Na₂O | >1-5 |
| K₂O | 0-4 |
| with Na₂O + K₂O | >1-5 |
| MgO | 0-5 |
| CaO | 3-<8 |
| SrO | 0.1-8 |
| BaO | 4.5-12 |
| with MgO + Ca + SrO + BaO | 10-25 |
| SnO₂ | 0-1.5 |
| ZrO₂ | 0-3 |
| TiO₂ | 0-2 |
| ZnO | 0-2 |

2) Aluminum borosilicate glass as claimed in claim 1, characterized by the following composition (in % by weight on an oxide basis):

| | |
|---|---|
| SiO₂ | >55-70 |
| B₂O₃ | 3-8 |
| Al₂O₃ | >12-17 |
| Na₂O | >1-<5 |
| K₂O | 0-2.5 |
| with Na₂O + K₂O | >1-<5 |
| MgO | 0.5-4 |
| CaO | 3-<8 |
| SrO | 0.1-4 |
| BaO | >5-11 |
| with MgO + Ca + SrO + BaO | 11-23 |
| SnO₂ | 0-1.5 |
| ZrO₂ | 0-3 |
| TiO₂ | 0-1 |
| ZnO | 0-1 |

3) Aluminum borosilicate glass as claimed in claim 1 or 2, wherein it contains at most 7% by weight, preferably at most 5% by weight, especially preferably at most<5% by weight B₂O₃.

4) Aluminum borosilicate glass as claimed in at least one of claims 1 to 3, wherein it contains at most<4% by weight of the total of Na₂O and K₂O.

5) Aluminum borosilicate glass as claimed in at least one of claims 1 to 4, wherein it contains 0-1% by weight K₂O.

6) Aluminum borosilicate glass as claimed in at least one of claims 1 to 5, wherein it contains at least 0.1% by weight ZrO₃.

7) Aluminum borosilicate glass as claimed in at least one of claims 1 to 6, wherein it additionally contains:

| | |
|---|---|
| As₂O₃ | 0-1.5 |
| Sb₂O₃ | 0-1.5 |
| CeO₂ | 0-1.5 |
| Cl⁻ | 0-1.5 |
| F⁻ | 0-1.5 |
| SO₄²⁻ | 0-1.5 |
| with As₂O₃ + Sb₂O₃ + CeO₂ + | ≦1.5 |
| Cl⁻ + F⁻ + So₄²⁻ | |

8) Aluminum borosilicate glass as claimed in at least one of claims 1 to 7, which has a coefficient of thermal expansion α_{20/300} between 4.5×10⁻⁶/K and 6.0×10⁻⁶/K and a transformation temperature T_{g}>630° C.

9) Use of an aluminum borosilicate glass as claimed in at least one of claims 1 to 8 as the substrate glass in thin layer photovoltaics.

10) Use as claimed in claim 9 for solar cells based on the compound semiconductor Cu(In, Ga) (S, Se)₂
